(19) United States
(12) Patent Application Publication
(10) Pub. No.: US 2016/0364995 A1
(43) Pub. Date: Dec. 15, 2016

(54) COLLABORATIVE TRAINING SYSTEM AND METHOD, COMPUTER PROGRAM PRODUCT, AS WELL AS AN INSTRUCTOR UNIT AND A PARTICIPANT UNIT FOR USE IN THE TRAINING SYSTEM

(71) Applicant: Mind Myths Limited, Strandhill (IE)

(72) Inventor: Mark RODDY, Strandhill (IE)

(73) Assignee: Mind Myths Limited, Strandhill (IE)

(21) Appl. No.: 15/212,793

(22) Filed: Jul. 18, 2016

(30) Foreign Application Priority Data
Jun. 11, 2015 (IE) 2015/0174

(51) Int. Cl. G09B 5/14; H04L 29/06; G06F 3/0488; G06T 19/00; G06F 3/01; G06F 3/0481

(52) U.S. Cl. CPC G09B 5/14; G06F 3/017; G06F 3/04817; G06F 3/04883; G06F 3/04815; G06T 19/006; H04L 67/38; H04L 65/4053; G06T 2200/24

(57) ABSTRACT

A system for collaborative training is provided that includes an instructor unit and a plurality of participant units. The instructor unit and the plurality of participant units are communicatively coupled to each other by a remote connection. The instructor unit enables the instructor to remotely control the virtual environment of a plurality of participants involved, while maintaining a good overview of their mental state and progress.

### BACKGROUND OF THE INVENTION

A 3D immersion provides for an intensive experience. Consequently, a training by offering a 3D immersion can be a powerful tool to help individuals to develop mental skills or to treat mental disorders.

To that end it is important that the content offered to the participant in said 3D immersion properly matches the needs of the participant. If this is not the case, the training is ineffective or worse, results in an aggravation to the mental disorder. However, dependent on the progress of the participant and his/hers specific sensitivity, the specific needs in this respect can strongly differ between participants and in time. Hence it is of the utmost importance that the instructor or therapist is well aware of the way in which the participant experiences the training. This is relatively easy, if the training is offered face to face, where the instructor can closely observe the participant. However, it would also be desirable to facilitate such training or therapy remotely, so that any individual can have access to this powerful way of treatment, regardless of the physical distance to the therapist or instructor offering the treatment. However, for a variety of reasons the remote nature of the training may prevent the instructor from being specifically aware of how the participant experiences the training. A possible aid in remote therapy could be a video link between the participant and the controller. However, such a video link may have an insufficient capacity for this purpose, or be absent, for example because the participant does not want to be remotely visible.

### SUMMARY OF THE INVENTION

Accordingly, it is an object of the present invention to provide an improved training system that enables a controller to remotely control a 3D immersive experience properly matching the current needs of the particular participant.

In accordance with this object an instructor unit is provided as claimed in claim 1. Various embodiment thereof are specified in claims 2-10. Additionally a participant unit is provided as claimed in claim 11. Various embodiments thereof are claimed in claims 12 to 15. Claim 16 specifies a training system wherein the instructor unit or an embodiment thereof and a plurality of participant units or embodiments thereof are communicatively coupled to each other by a remote connection. Furthermore, a method according to the present invention is claimed in claim 17. Additionally, a computer program product for causing a programmable system to carry out a method according to the present invention is claimed in claim 18.

### BRIEF DESCRIPTION OF THE DRAWINGS

These and other aspects of the invention are described in more detail in the drawings. Therein:

FIG. 1 schematically shows an embodiment of a training system according to the present invention,

FIG. 2 shows an embodiment of an instructor unit for use in the training system of FIG. 1,

FIG. 2A shows a detail of the embodiment of FIG. 2,

FIG. 3 shows an embodiment of a participant unit for use in the training system of FIG. 1,

FIG. 4 shows an exemplary display space of an instructor unit,

FIG. 5 shows another exemplary display space of an instructor unit.

FIG. 6 shows an alternative embodiment of an instructor unit for use in the training system of FIG. 1,

FIG. 7 shows an alternative embodiment of a participant unit for use in the training system of FIG. 1,

FIG. 8 shows parts of an embodiment of an instructor unit in more detail,

FIG. 9 shows parts of another embodiment of an instructor unit in more detail,

FIG. 10 shows parts of again another embodiment of an instructor unit in more detail,

FIG. 10A shows an example of a part suitable for use in the embodiment of FIG. 10,

FIG. 11 shows a part of still another embodiment of an instructor unit in more detail,

FIG. 12 schematically illustrates a method according to the present invention.

### DESCRIPTION OF EMBODIMENTS

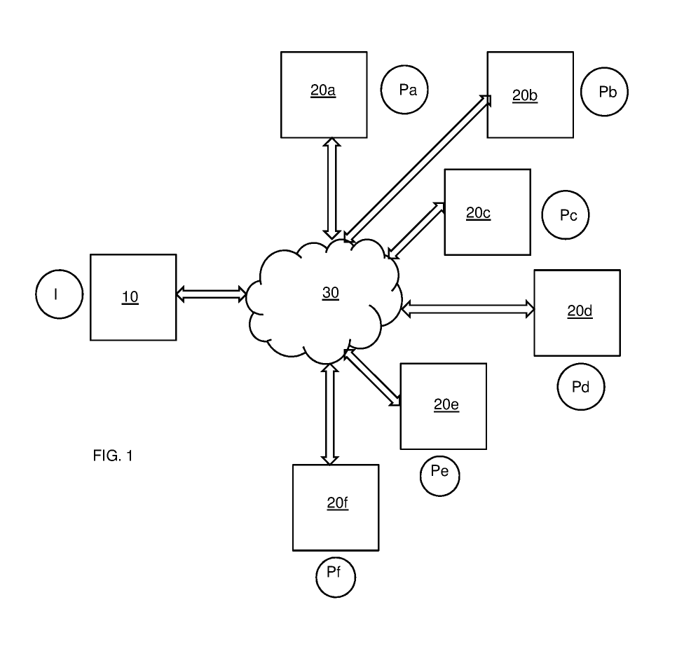

FIG. 1 schematically shows a training system comprising an instructor unit 10 for use by an instructor I. A plurality of participant units 20a, 20b, 20c, 20d, 20e, 20f for use by respective participants Pa, Pb, Pc, Pd, Pe, Pf is communicatively coupled with the instructor unit by a remote connection, for example by an internet connection as indicated by cloud 30. In use the participants are immersed in a virtual environment rendered by their participant units using participant specific control information transmitted by the instructor unit 10 via the remote connection to the participant units. The participant units 20a-20f in turn transmit participant specific state data via the remote connection to the instructor unit. By way of example six participant units are shown. However, the system may also be used with another number of participant units. For example, the system may include a large number of participant units, of which only a subset is active at the same time.

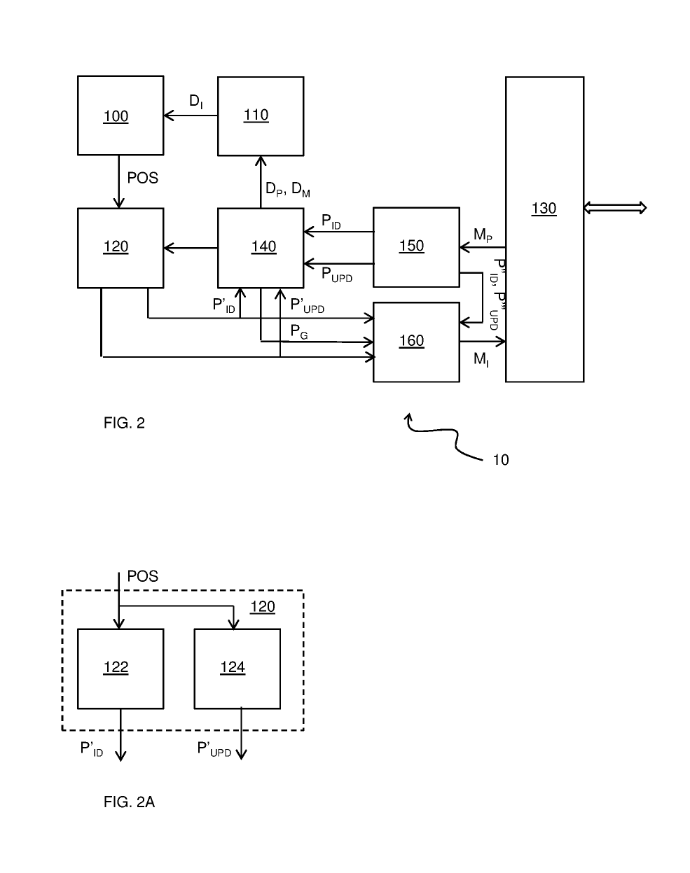

FIG. 2 shows an embodiment of the instructor unit 10 in more detail. The instructor unit 10 shown therein comprises a display facility 100. An image rendering facility 110 is further provided for rendering image data D_{I} to be displayed in a display space of the display facility. The image data D_{I} to be displayed includes a visual representation of participants in respective spatial regions of the display space. A spatial region associated with the participant may be a two-dimensional region on a display screen, but it may alternatively be a three dimensional region in a three dimensional space. The regions may be formed by a regular or an irregular tessellation. In an embodiment the regions are mutually separated by isolation regions that are not associated with an active participant. This is advantageous in that it reduces the probability that an instructor unintendedly affects the experience state of another participant than the one intended.

The image rendering facility 110 renders the image data D_{I} using participant data D_{P}, obtained from storage facility 140, that is associated with respective participants Pa, . . . , Pf using respective participant units 20a, . . . ,20f to be communicatively coupled to the instructor unit in the collaborative training system. The participant data D_{P} includes for each participant at least information to be used for identifying the participant and associating data that associates respective participant units with respective spatial regions in the display space. Additionally the participant data D_{P} may include virtual environment control data for specifying a virtual environment to be generated for that participant. The participant data may further include participant state data indicative for detectable aspects of a participant's state, e.g. the participants' posture, the participants' movements, physiological parameters, such as heart rate, breathing rate and blood pressure. Many of these parameters can also be indicative of a participants' mental state. One or more specific mental state indicators may be derived from one or more of these parameters. These derived indicators may be derived in the instructor unit or by the participant unit of the participant involved.

The image rendering facility 110 may further use model data D_{M} of a virtual environment to render the image data D_{I}. The model data D_{M} may be identical to the virtual environment control data. Alternatively, the model data D_{M} may be a simplified version of the virtual environment control data. In an embodiment the instructor unit may include a virtual environment rendering facility comprising the image rendering facility 110 and the model data D_{M} may be used to render a virtual environment for the instructor that is identical to the virtual environment that is experienced by the participants that are instructed by the instructor.

Alternatively, the image rendering facility may be used to render a more abstract version of that virtual environment. For example, the image rendering facility 110 may render a two-dimensional version of the virtual environment. In this case the model data D_{M} may be a simplified version of the virtual environment control data that is made available to the participant units for rendering the virtual environment.

The instructor unit 10 further includes a communication facility 130. The communication facility 130 is provided to receive participant state data indicative for detectable features of respective participants' states from their respective participant units 20a, . . . ,20f. The communication facility is further provided to transmit virtual environment control data for specifying a virtual environment to be generated for respective participants' by their respective participant units.

The instructor unit 10 still further includes an update facility 150 that receives participant messages M_{P} from the communication facility 130. In operation the update facility 150 determines an identity P_{ID} of the participant from which the message originates and updates the visual representation of the identified participant on the basis of the participant state data P_{UPD} conveyed by the message. In the embodiment shown this is achieved in that the update facility updates a model of the participant with the participant state data stored in storage facility 140, and that the image rendering facility 110 renders an updated virtual representation on the basis of the updated participant state data.

The instructor unit 10 further includes a user input facility 120 to receive user input to be provided by the instructor. User input to be provided by the instructor includes a gesture having a spatial relationship to the display space. In response to the user input the user input facility provides an identification P′_{ID} of the participant designated by the user input and participant environment control information P′_{UPD} that specifies the virtual environment to be generated, or a modification thereof, for the designated participant.

In case the display space is defined by a two-dimensional screen, the user input may involve pointing to a particular position on that screen, and the spatial relationship is the position POS pointed to. If the display space is three-dimensional the instructor may point to a position POS in said three dimensional space. Also in case of a two-dimensional case, an embodiment may be contemplated wherein the user can point to a position in a 3D space, and wherein said position is mapped to a position POS in the 2D display space. The position pointed to or the mapped position can be used as an indicator for the identity of the participant. The gesture used for providing user input does not need to be stationary. The gesture may for example involve a trajectory from a first position to a second position in the display space. In that case one of the positions POS may indicate the participant and the other one may indicate an exercise to be assigned to that participant or a change of the virtual environment. Likewise a trajectory in 3D space may be mapped to a trajectory in 2D space wherein the mapped position serves to indicate the participant and the (changes in) the environment to be applied for said applicant. The user input may be complemented in other ways. For example, in order to assign a particular environment or exercise to a particular participant, the instructor may point to a position in a spatial region of that participant and the instructor may subsequently type a text specifying that particular environment or exercise in an input field that may be present continuously or that pops up after pointing to that position. In some cases it may be contemplated to allow spatial regions of mutually different participants to partially or fully overlap each other. This renders it possible for the instructor to simultaneously control the virtual environment of those participants by pointing to a position where the spatial regions assigned to these participants overlap with each other. Also it may be contemplated to assign a spatial region to a group of participants in addition to the spatial regions of the individual participants. This may allow the instructor to simultaneously control the virtual environment of the group by pointing at a position inside the spatial region of the group, but outside the spatial regions of the individual participants. The instructor may still control the virtual environment of a single participant by pointing to a position inside the spatial region of that participant.

An example of the user input facility 120 is illustrated in FIG. 2A. Therein a first module 122 identifies the participant indicated by the gesture and issues an identification signal P′_{ID} reflecting this identification. A second module 124 determines which modification is to be implemented and issues a signal P′_{UPD} specifying this modification.

The identification P′_{ID} of the participant designated by the user input and participant environment control information P′_{UPD} that specifies the virtual environment to be generated or the modification thereof is provided to storage facility 140 to update its contents. As a result, the image rendering facility 110 renders an updated virtual representation on the basis of the updated participant state data.

The identification P′_{ID} of the participant designated by the user input and participant environment control information P′_{UPD} that specifies the virtual environment to be generated or the modification thereof is also provided to a message preparing facility 160.

The message preparing facility 160 receives the identification P′_{ID} of the participant designated by the user input and participant environment control information P′_{UPD} that specifies the virtual environment or modification thereof. In response thereto it prepares a message M_{I} to be sent by communication facility 130 to the participant unit of that participant, so that the participant unit can implement the virtual environment or exercise for the participant. The message preparing facility may also send the messages to further participants that participate in the same group as the participant that is specifically designated by the instructor, so that changes that are experienced by the designated participant are also visible to those other participants. To that end the message preparing facility receives an indication P_{G} about the group in which the participant is participating. In some cases the participant may be the only member of the group.

The message preparing facility 160 may further receive information specifying update information P″_{UPD} from a participant with identification P″_{ID}. The message preparing facility 160 can prepare messages M_{I} based on this information for other participants in the same group as the participant with this identification, so that the participant units of these other participants can implement the virtual environment or exercise for these other participants.

Therewith participants in the same group maintain a coherent view of each other. For example if participant A turns his/her head to speak to another participant B, this is communicated by message M_{P} to the instructor unit 10. In turn, the update facility 150 receives this message M_{P}, provides the update information P_{UPD}, P_{ID} to the storage facility 140 so as to achieve that the change in posture is visible to the instructor. Additionally the update facility 150 provides the update information P″_{UPD}, P″_{ID} to the message preparing facility 160 that sends messages M_{I} conveying this update information to the participant unit of participant B and to other participants in the same group, if any.

At the site of the instructor, updating the visual representation of an identified participant can be realized by modifying the appearance of the visual representation (e.g. the gender, weight, height or age group of a participant's avatar) and/or by modifying the arrangement of the participant's spatial region in the display space. The arrangement of the participants' spatial region may be modified for example by the instructor, to assign the participant to a group. The arrangement of spatial regions may also change as a result of the group dynamics. For example spatial regions of participants chatting with each other may be rearranged near each other. A spatial region of a participant who does not interact with the other group members may be arranged at some distance from the spatial regions of the other group members, so as to alert the instructor of this situation.

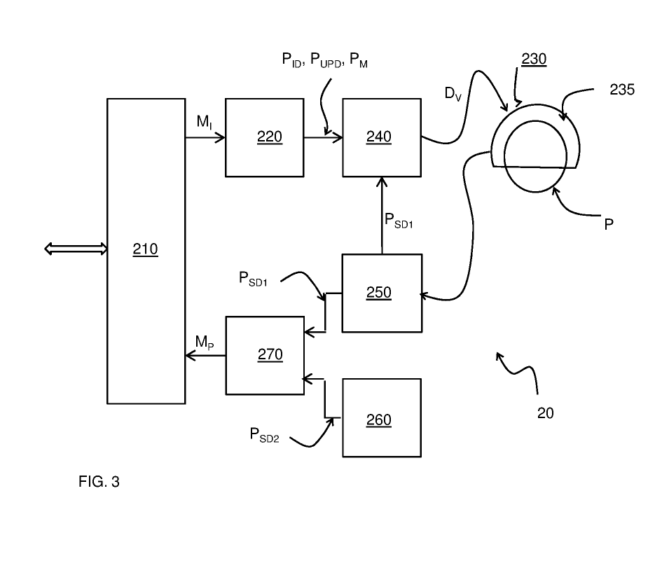

An embodiment of a participant unit 20 is shown in more detail in FIG. 3. The participant unit shown therein, for example one of the participant units 20a, . . . ,20f, comprises a participant communication unit 210 to couple the participant unit 20 to an instructor unit 10 by a remote connection 30 (See FIG. 1) to form a training system. The participant unit further comprises a participant storage space in a unit 240 that stores third model data, specifying an environment and fourth model data at least including data indicative for an instantaneous position of the participant P. The participant unit also includes an update unit 220 that receives messages M_{I} from the instructor unit conveying update information. The update information may include participant identification information P_{ID}, modifications P_{UPD} specified for the state of the participant identified therewith and modifications P_{M} specified for the virtual environment to be rendered. The modifications P_{UPD} specified for the state of the identified participant may for example include a posture of the identified participant.

In the embodiment shown the participant P wears a headset 230 that includes 3D visualization means. In another embodiment such 3D visualization means may be provided as a screen in front of the participant P or by other means. Also audio devices may be provided, for example implemented in the headset, to enable the participant P to talk with the instructor or with other participants. The participant unit also includes a spatial state sensor module 235, here included in the headset 230 to sense the participants' physical position and orientation. The spatial state sensor module is coupled to spatial state processing module 250 to provide spatial state data P_{SD1} indicative of the sensed physical position and orientation.

The unit 240 also includes a virtual environment data rendering facility to render virtual environment data D_{V} to be used by the headset 230 or by other virtual environment rendering means.

A participant message preparing unit 270 is coupled to the spatial state processing module 250 to prepare messages M_{P} to be transmitted from the participant unit 20 to the instructor unit 10 that convey the spatial state data P_{SD1} provided by the spatial state processing module 250. The spatial state processing module 250 also directly provides the spatial state data P_{SD1} to the participant storage space so as to update the stored information for the participant P. Alternatively it could be contemplated that the update unit 220 receives a message from the instructor unit conveying this spatial state data P_{SD1}.

The participant unit further comprises a state sensor 260 for sensing a detectable feature associated with a mental state of the participant and for providing state data P_{SD2} indicative of the sensed detectable feature. The state sensor 260 is coupled to the participant message preparing unit 270 to prepare message data M_{P} for transmission by the participant communication unit to the instructor unit. In an embodiment the state sensor may include the spatial state sensor module 235. Signals obtained from spatial state sensor module 235, being indicative of the way a participant moves or the posture of a participant can be processed to provide for an indication of the participants' mental and/or physical state. Other detectable features indicative of a participants' mental and/or physical states, may include physiological data, such as a heart rate, a respiration frequency and a blood pressure etc. Another detectable feature may be an indicator that is explicitly provided by participant, for example by pressing a button.

In general, the virtual environment of the participant is the combination of offered stimuli. In the first place, this may include graphical data, such as an environment that is rendered as a three dimensional scene, but alternatively, or additionally this may include auditory stimuli, e.g. bird sounds or music and/or motion. The latter may be simulated by movements of the rendered environment or by physical movements e.g. induced in a chair in which the participant is seated.

The virtual environment may be static or dynamic.

It is noted that the instructor unit may be provided with means to provide the instructor with the same virtual environment as the participants. Alternatively, the instructor may have a more abstract view. For example the participant unit may render a three-dimensional representation of a landscape as part of a virtual environment for the participant using it, whereas the instructor unit may display the same landscape as a two-dimensional image. However, the third model data used by the participant unit to render the three-dimensional representation may be a copy of the first model data used by the instructor unit to render the two-dimensional image. The three-dimensional representation may be rendered in front of the participant, but alternatively fully immerse the participant, i.e. be rendered all around the participant.

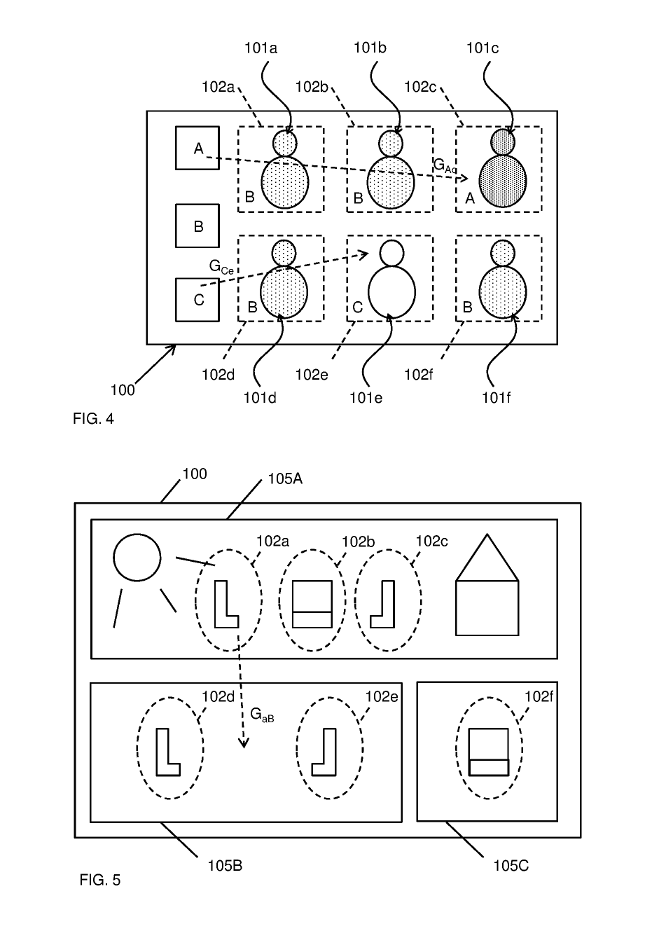

FIG. 4 shows an example of image data rendered on a display space of a display facility 100 of the instructor unit 10, enabling the instructor to monitor the state and progress of the participants and to control their virtual environment. In this case the display facility 100 has a display screen as its display space, where it renders a two-dimensional image. The image data displayed on the display includes a visual representation of the participants Pa, . . . , Pf, in the form of icons 101a, . . . , 101f in respective spatial regions, indicated by dashed rectangles 102a, . . . ,102f, of said display space. The rectangles may be visible or not. In this case the spatial regions are mutually separated by isolation regions. The participants' visual representation in respective spatial regions of the display space is rendered in accordance with participant state data received from each participants' respective participant unit. For example the icon representing the participant may have a color or other visible parameter that indicates a mental state of the participant. By way of example, the dark hatching of icon 101c indicates that the participant associated with this icon is not at ease and the unhatched icon 101e indicates that the therewith associated participant is not alert. In this way the instructor immediately is aware that these participants need attention.

In the embodiment shown, the display facility 100 also displays control icons (A,B,C) in respective spatial regions outside the spatial regions (102a, . . . ,102f) associated with the participant units. These control icons are associated with respective control data for rendering a virtual environment or exercise in said virtual environment.

The instructor I, noting that a participant currently does not have the proper environment may change the virtual environment by a gesture involving a dragging movement from the position in a spatial region of a control icon to a position in a spatial region associated with a participant. For example the instructor may make dragging movement G_{Ac} from a position in the region of icon A to a position in the region 102c associated to participant Pc. The user input facility 120 is arranged to detect this gesture. Upon detection of the gesture G_{Ac} the input facility provides an identification P′_{ID} that indicates the identity of the participant associated with spatial region 102c, and further provides the control data associated with the control icon A as the participant environment control information P′_{UPD} to be transmitted to the participant unit, e.g. 20c of the identified participant. As a result this participant unit 20c changes the virtual environment of the participant in accordance with that control information P′_{UPD}. This change may be visualized in the display, for example by a copy of the control icon in the spatial region associated with the participant. In the same manner, the instructor can change the virtual environment of the participant associated with spatial region 101e, for example, by the dragging movement of gesture G_{Ce} from control icon C to spatial region 101e associated with the participant unit 20e of participant Pe. The user input facility 120 may for example include a touch screen panel or a mouse for use by the instructor to input the gesture. Alternatively, instead of a dragging movement the instructor may provide control input by pointing at a spatial region. The instructor may for example point at a spatial region 102c, and the input facility 120 may be arranged to show a dropdown menu on the display facility, from which the instructor may select a virtual environment. Alternatively the input facility may ask the instructor to type the name of an environment.

FIG. 5 shows another example of image data rendered on a display space of a display facility 100 of the instructor unit 10. In the embodiment shown, the image rendering facility partitions the display space in a plurality of main regions 105A, 105B and 105C. These main regions correspond to respective subgroups of participants, as indicated by their spatial regions. For example main region 105A includes the spatial regions 102a, 102b, 102c. Main region 105B includes the spatial regions 102d, 102e. Main region 105C includes a single spatial region 102f. Participants in a same subgroup are aware of each other, e.g. see each other, or see each others avatars, and can communicate with each other, but they cannot see or communicate with participants in other subgroups. Each subgroup as indicated by its main region, may have a proper virtual environment. For example participants in the subgroup associated with main region 105A experience a rural scene as their virtual environment, participants in the subgroup associated with main region 105B experience a seaside view and the participant in the subgroup associated with main region 105C has again another virtual environment, for example a mountain landscape. In the embodiment shown the instructor has a simplified impression of the environments of each of the subgroups as shown in the respective main regions 105A, B, C. In another embodiment, the instructor may wear a 3D headset and may be immersed in the same 3D environment as one of the subgroups. In that embodiment, the instructor may for example be able to switch from one subgroup to another one by operating selection means. Alternatively the instructor may be aware of each of the subgroups for example, in that they are arranged in mutually different ranges of his/hers field of view.

In an embodiment the instructor may reorganize the partitioning in subgroups by a dragging movement from a first position inside a spatial region associated with a participant to a second position inside a main spatial region. In the embodiment the user input facility 120 is arranged to detect a gesture that involves a dragging movement associated with a participant to a main spatial region. The user input facility 120, upon detection of this gesture provides an identification P′_{ID} indicative for the identity of the participant associated with the identified spatial region, and provides control data indicating that the identified participant is rearranged to the subgroup associated with the main region as indicated by the detected gesture. This has the result that the participant is moved from the subgroup associated with main region in which the participants' region was originally arranged, to the subgroup associated with the main region including the second position. For example, when the instructor I makes a dragging movement G_{aB}, this has the effect that participant Pa is transferred from the subgroup associated with main region 105A to the subgroup associated with main region 105B.

The grouping data as stored in the storage facility 140 is updated by user input facility to reflect this change in subdivision. The message preparing facility 160 uses the grouping data, indicated by input signal P_{G}, to distribute messages with participant data exclusively to other participants in the same subgroup. Therewith the grouping data serves as authorization data that determines which participants can be aware of each other. For example, when a participant associated with region 102c changes his/her orientation, the corresponding participant transmits a message with participant state information to the instructor unit. The message preparing facility 160 selectively distributes this information to the participant units associated with the participants in the same subgroup, as indicated by main region 105A. Upon receipt the corresponding participant units, in this case 20a, 20b update the virtual environment of their participant by changing the orientation of the avatar of the participant according to the state information. However, if the participant associated with region 102a no longer is part of the subgroup associated with main region 105A, the state information of this participant is no longer distributed to the participant of region 102a. Similarly, this participant no longer receives state information from participants of main region 105A. Instead, participant Pa is now part of the subgroup of region 105B. Consequently, participants Pa, Pd, Pe are in communication with each other.

The capabilities offered by the embodiments of the present invention to the instructor to flexibly arrange the participants in a common group, in subgroups or as an individual offer various opportunities.

The instructor may for example organize a first session, wherein all participants form part of a common group for a planar session wherein the instructor for example explains the general procedure, general rules to take into account, such as respect for other participants, confidentiality and to remind the participants to take care of themselves. Also the participants may introduce themselves in this phase, and explain what they want to achieve. The instructor may then ask the participants to continue individually with a body scan exercise, e.g. in the form of 20-30 min practice in bringing attention to their breathing and then systematically through various parts of the body to focus attention to awareness of their senses, and also to learn to move attention from one thing to another. In this phase the group of participants may be arranged as ‘subgroups’ comprising each one participant. In these individual sessions a silent retreat may be provided, wherein participants get an opportunity to develop their mindfulness practices, without the distraction or discussion/enquiry inputs. The instructor (facilitator) may lead the individual participants through various practices, introduce various readings, poems and virtual environments. These may be combined with physical practice, such as yoga stretches, etc. In this phase the participants may be able to individually communicate with the instructor. Subsequent to this phase the instructor may reorganize the participants as a group, enabling them to exchange experiences with each other.

In another phase of the process, the instructor may also arrange the participants in subgroups of two or three, asking them to discuss a subject in each subgroup. Subsequent to this phase, the instructor may unify the participants in a single group asking the participants to report the discussion in each subgroup.

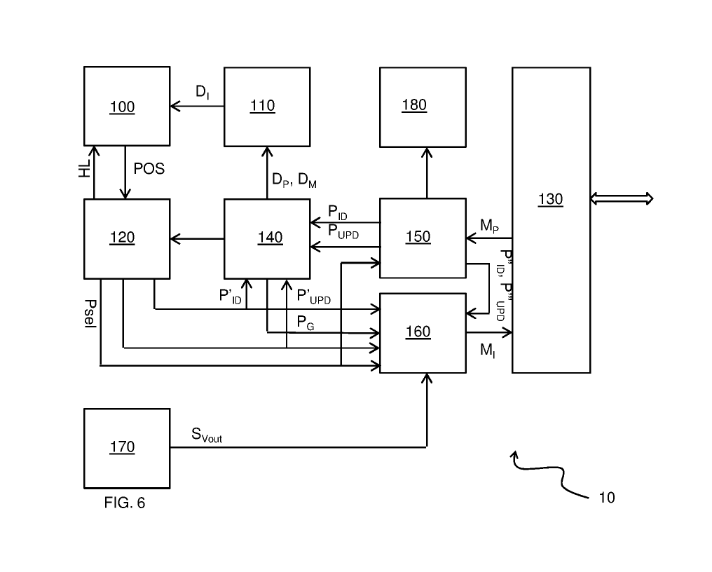

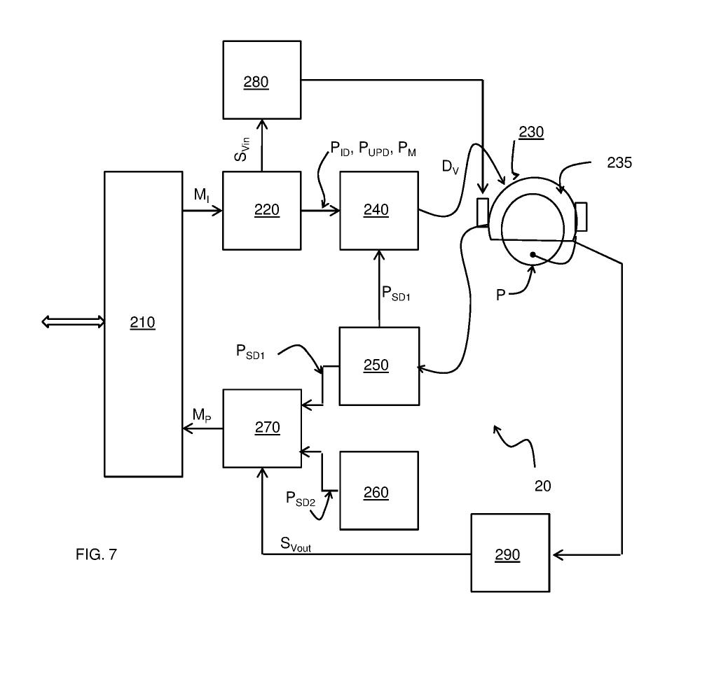

FIG. 6 shows an alternative embodiment of an instructor unit 10. The instructor unit of FIG. 6 may be used in combination with participant units 20 as shown in FIG. 7. In these FIGS. 6, 7 parts corresponding to those in FIGS. 2 and 3 respectively have the same reference numeral. In the embodiment shown in FIG. 7, the instructor unit is provided with audio input facility 170 and an audio output facility 180. The message preparing facility 160 also serves for distribution of audio data and is arranged to distribute audio data of participants in the same subgroup between each other, therewith enabling a conversation between them. In particular the message preparing facility 160 enables the instructor to selectively communicate with a particular participant, with a subgroup of participants, or with all participants. This is achieved in that the message preparing facility 160 receives a selection signal Psel from the input unit. The selection signal may indicate that the instructor currently has selected a particular participant, e.g. participant Pc by pointing to the region 102c in the display space of display 100. Alternatively, the instructor may select a particular subgroup, for example by pointing at a position inside main region 105A as shown in FIG. 5, but outside the individual regions 102a, 102b, 102c therein. Nevertheless also in this case the instructor may select a particular participant by pointing at a position inside the spatial region of that participant. By pointing at a position outside the main regions, the instructor may indicate that he/she wants to communicate with all participants. The input facility 120 may cause the display facility 100 to show the selection of a participant, a subgroup of participants or all participants, by highlighting the spatial regions of the participants that are included in the selection, by highlighting a main region, or by highlighting the entire display space.

In the embodiment shown, the update facility 150 also serves to selectively process incoming messages M_{P} conveying audio information in accordance with the selection signal Psel. Audio output facility 180 exclusively receives the audio information of the selected participant, or subgroup of participants, unless the selection signal Psel indicates that all participants are selected. The message preparing facility also selectively routes audio messages between selected participants. For example if the instructor selected participant Pb by pointing spatial region 102b, the message preparing facility may continue to route audio conveying messages between participants Pa and Pc, but not between Pb and Pa or Pc and Pa.

In the participant unit of FIG. 7, the update unit 220 also provides audio data Svin to audio processor 280. The participant message preparing unit 270 receives audio data S_{Vout} from audio processor 290 coupled to a microphone attached to the headset.

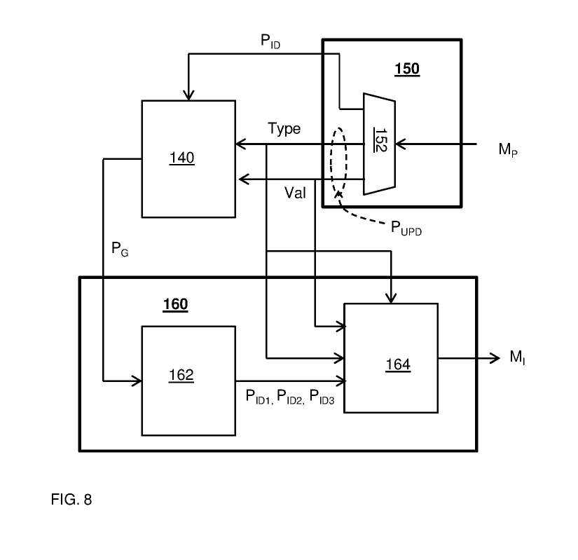

FIG. 8 shows parts of an embodiment of an instructor unit in more detail. As shown FIG. 8, the update unit 150 includes a decomposition part 152 for decomposing the incoming message M_{P} into data P_{ID} indicative for the participant that sent the message, data Type, indicative for the type of message, e.g. participant state data, voice data, etc, and data Value, indicative for the substance of the message, e.g. indicating the actual movement of the participant or data that can subsequently reproduced as voice data. The data Type and data Value together represent update information P_{UPD}. The data P_{ID} is used to address participant specific data stored in the storage facility 140, such as the indicator P_{G}. The message preparation unit 160 includes an address generator 162 that uses the indication P_{G} about the group in which the participant is participating to generate one or more addresses for distribution. A message sender 164 transmits the update information P_{UPD}, to the participants as indicated by those one or more addresses. However, the message sender 164 may perform this function selectively dependent on the Type. For example, the message sender 164 may send message of Type audio and messages of Type public participant data to the participants indicated, but may not send messages of Type private participant data. Public participant data may for example be data indicative of a participants' posture and private participant data may be indicative of a participants' emotions.

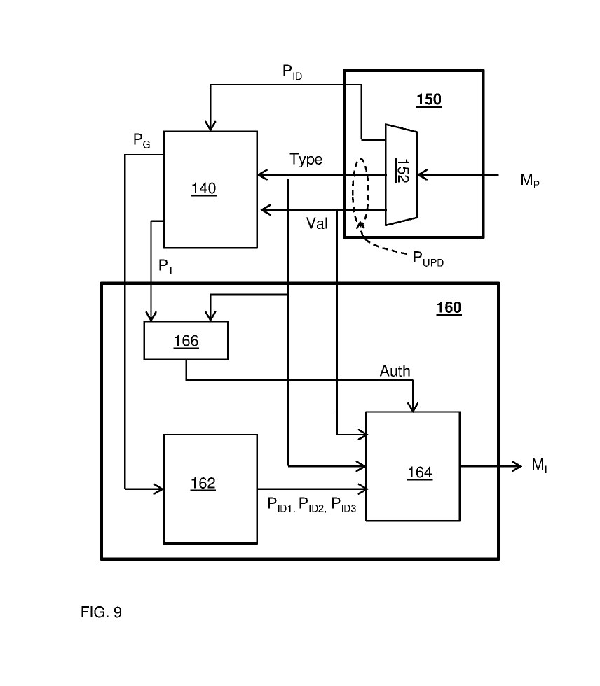

FIG. 9 shows parts of an embodiment of an instructor unit in more detail. The message preparation unit 160 comprises an authorization part 166 having a first input to receive a signal P_{T} that specifies authorization settings of the participant indicated by data P_{ID} and having a second input to receive the signal Type indicative for the type of message. The type comparator 166 generates an authorization signal Auth that selectively authorizes passing of messages in accordance with the specification as indicated by signal P_{T}. By way of example, the following types of messages may be considered:

Public participant data, private participant data and voice data. The signal P_{T} may be provided as a vector of binary indicators, e.g. (1,0,1) wherein a 1 indicates that the particular participant wants to share said data with others and a 0 indicates that the participant does not want to share the data. Likewise the data Type may be represented as such a vector, and the type comparator, can generate the authorization signal Auth as the inner product of both vectors.

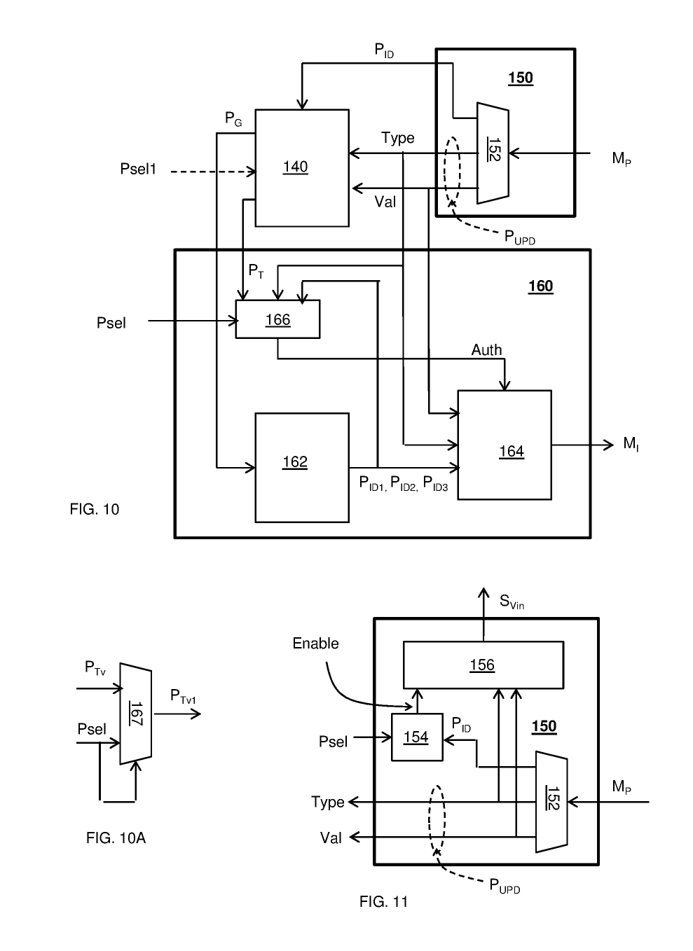

FIG. 10 shows parts of a still further embodiment of an instructor unit in more detail. The message preparation unit 160 has an alternative version of the authorization part 166 that selectively authorizes distribution of messages M_{I}, depending on the type of message Type, and the addressee. In this case the signal P_{T} specifies authorization settings of the participant indicated by data P_{ID}, for each of the other participants that may potentially be provided with update information. The authorization settings may be different for different other participants. For example in case the subgroup of the participant indicated by data P_{ID}, further includes participants P_{ID1}, P_{ID2}, P_{ID3}, then the signal P_{T} may be provided as a vector of binary indicators, e.g. (1,0,1; 1,1,1; 1,0,1) to indicate that the participant indicated by data P_{ID}, wants those messages conveying private participant data are shared exclusively with participant P_{ID2}. It is presumed all information shared by the user messages is shared with the instructor. However, alternative embodiments are conceivable, wherein participants may also indicate that messages of a specific type are not shared with the instructor, in a similar way as they may specify that they are not shared with certain fellow participants.

The authorization mechanism as described with reference to FIG. 10 may be applied similarly by the instructor to select one or more participants to be included in a conversation. In the embodiment shown in FIG. 10, the selection signal Psel can be used by authorization part 166 as an additional signal to selectively distribute messages conveying audio information. The selection signal Psel may include a first indication to indicate whether or not a selection is made by the instructor and a set of indications that indicate which participants are included in the conversation. If the first indication indicates that the instructor did not make a specific selection, the authorization part authorizes distribution of audio type messages as specified by signal P_{T}. However, if the first indicator indicates that a selection is made, this selection overrules the specification by signal P_{T}. This is schematically indicated by a multiplexer function 167, as shown in FIG. 10A. Alternatively however, as indicated by the dashed arrow in FIG. 10, a selection signal Psel1 may be used to modify the content in the storage facility 140, so as to indicate therein which participant(s) currently have a conversation with the instructor, and which participants have a conversation with each other. The storage facility 140 may for example comprise a record for each participant as schematically indicated in the following overview.

TABLE 1
Participant record

| | |
|---|---|
| Environment data | E.g. 3D environment and audio |
| Group data | P_{ID1}; P_{ID2}; P_{ID3} |
| Authorization per type | P_{T11}, P_{T12}, P_{T13}, P_{T14}; |
| | P_{T21}, P_{T22}, P_{T23}, P_{T24;} |
| | P_{T31}, P_{T32}, P_{T33}, P_{T34}; |
| | I_{T1}, I_{T2}, I_{T3}, I_{T4}; |
| Private data | E.g. indicators for mental state |
| Public data | E.g. indicators for participants posture |

In this example the group data is indicated by the indicators P_{ID1}; P_{ID2}; P_{ID3}, specifying a reference to participants that are in the same subgroup as this participant. Alternatively, instead of specifying here each of the subgroup members, this entry may include a pointer to an entry in a second table that specifies for each group which participants are included therein.

The authorization per type specifies which type of messages may be transferred between each of the group members. I.e. P_{Tmn} specifies whether or not messages of type n may be distributed to participant m. In addition the authorization per type specifies which type of messages may be transferred between. I.e. I_{Tn} specifies which messages of type n allowed to be shared by the instructor. It is noted that the participant record may also include voice data, e.g. a record with all conversations in which the participant participated.

FIG. 11 shows an embodiment of an update facility 150. The update facility 150 has an additional audio decoding part 156 and a selection part 154. The selection part 154 issues an enable signal Enable that selectively enables the audio decoding part 156 to decode messages including voice data if the incoming message originates from a participant included in the selection indicated by Pₛₑₗ. To facilitate the instructor in determining which of the participants is currently speaking, the image rendering facility 100 of the instructor unit 10 may for example highlight that currently speaking participant, or temporally enlarge the participants' spatial region. Alternatively, or in addition, this may be visualized by animating the participants' avatar to mimic the act of speaking.

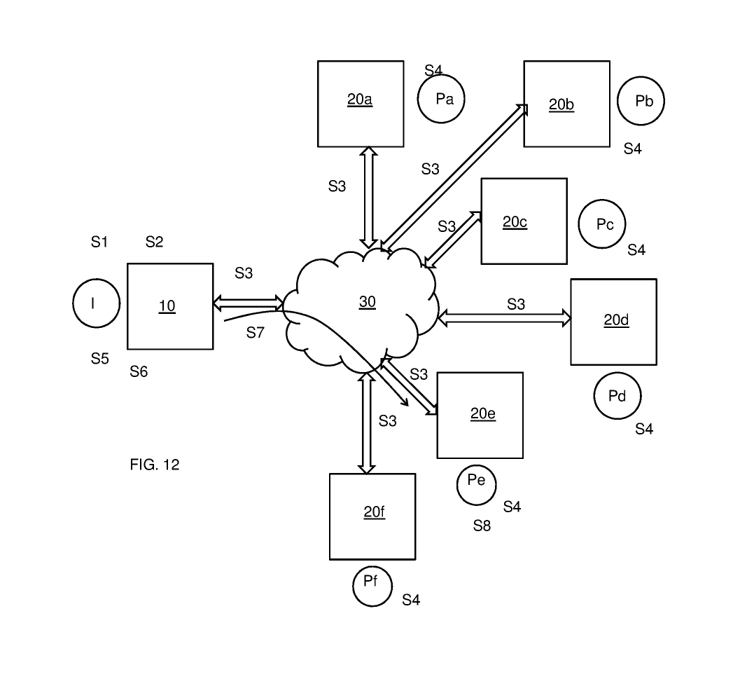

In summary the present invention facilitates collaborative training of a plurality of participants at respective participant locations by an instructor at an instructor location, wherein the participants and the instructor may be at mutually non-co-located locations. The non-co-located locations may even be remotely arranged with respect to each other, e.g. in different cities or different countries. As schematically illustrated in FIG. 12, the collaborative training involves the following.

In the instructor location image data is rendered in a display space perceivable by the instructor I (step S1). The display space comprises spatial regions associated with respective participants Pa, . . . , Pf.

In a storage space applicant specific data is maintained (Step S2) that includes at least data associating each participant with a respective spatial region in the display space and virtual environment control data for specifying a virtual environment to be rendered for the participant. The storage space may be arranged at the instructor location but may alternatively be in a secured server at a different location.

The virtual environment control data is communicated (S3) to the various participants, and a virtual environment is rendered (S4) for these participants at their proper location in accordance with the communicated virtual environment control data.

The instructor provides (S5) control input at the instructor location, in the form of a spatial relationship between a user gesture and the display space.

A spatial region is identified (S6) that is indicated by the gesture and the virtual environment control data of the participant associated with the identified spatial region is modified. The modified virtual environment control data is transmitted (S7) to the participant, e.g. participant Pe and the virtual environment of the participant is modified (S8) in accordance with said communicated virtual environment control data.

In the claims the word “comprising” does not exclude other elements or steps, and the indefinite article “a” or “an” does not exclude a plurality. A single component or other unit may fulfill the functions of several items recited in the claims. The mere fact that certain measures are recited in mutually different claims does not indicate that a combination of these measures cannot be used to advantage. Any reference signs in the claims should not be construed as limiting the scope.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

As will be apparent to a person skilled in the art, the elements listed in the apparatus claims are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a hard disk or a flash memory, downloadable via a network, such as the Internet, or marketable in any other manner.

1. An instructor unit for use in a collaborative training system that further includes a plurality of participant units to be communicatively coupled with the instructor unit, the instructor unit comprising:
a display facility having a display space;
a storage facility storing at least associating data, associating respective participant units with respective spatial regions in the display space;
an image rendering facility for rendering image data to be displayed in the display space, the image data to be displayed including a visual representation of participants in the respective spatial regions;
a user input facility for accepting user input by detection of a spatial relationship between a user gesture and the display space, for identifying a spatial region of said respective spatial regions based on said spatial relationship for providing an identification indicative for an identity of a participant associated with the identified spatial region, and for providing participant environment control information that specifies the virtual environment or modification thereof, to be provided to the participant unit of the identified participant;
a communication facility for receiving participant messages conveying state data indicative for detectable features of respective participants' states from their respective participant units, and for transmitting instructor messages conveying virtual environment control data for specifying a virtual environment to be generated for respective participants' by their respective participant units;
an update facility for receiving the participant messages from the communication facility, for retrieving an identity of a participant and the participant state data from the participant messages and for updating the visual representation of the identified participants in accordance with the retrieved participant state data; and
a message preparing facility that receives the identification of the participant designated by the user input and the participant environment control information and in response thereto prepares a message to be sent by communication facility to the participant unit of that participant,
wherein the image rendering facility is arranged to render the visual representation of each participant in accordance with participant state data received from each participants' respective participant unit.

2. The instructor unit according to claim 1, the storage facility further storing model data specifying a virtual environment.

3. The instructor unit according to claim 1, the storage facility further storing participant state data for respective participants.

4. The instructor unit according to claim 1, the storage facility further storing authorization data, specifying which participant data is shared with other participants and wherein the message preparing facility prepares messages for distribution of participant data to other participants in accordance with said authorization data.

5. The instructor unit according to claim 4, wherein said authorization data includes grouping data indicative of a subdivision of the participants in subgroups, wherein the message preparing facility prepares messages for distribution of participant data of a participant only to other participants in the same subgroup as said participant.

6. The instructor unit according to claim 1, wherein the display facility is further provided to display control icons in respective spatial regions outside the spatial regions associated with the participant units, which control icons are associated with respective control data for rendering a virtual environment or exercise in said virtual environment, and wherein the user input facility is arranged to detect a gesture that involves a dragging movement from a spatial region of a control icon, to a spatial region associated with a participant unit, wherein the user input facility, upon detection of said gesture provides an identification indicative for the identity of the participant associated with the identified spatial region, and provides the control data associated with the control icon as the participant environment control information to the participant unit of the identified participant.

7. The instructor unit according to claim 5, wherein the display facility is further provided to display the visual representation of participants of mutually different groups in mutually different main regions of the display space.

8. The instructor unit according to claim 7, wherein the user input facility is arranged to detect a gesture that involves a dragging movement from a spatial region associated with a participant unit to a main region of the display space, wherein the user input facility, upon detection of said gesture provides an identification indicative for the identity of the participant associated with the spatial region identified by the gesture, and provides control data indicating that the identified participant is rearranged to the subgroup associated with the main region as indicated by the detected gesture.

9. The instructor unit according to claim 5, wherein the message preparing facility also serves for distribution of audio data, the message preparing facility being arranged to distribute audio data of participants in the same subgroup between each other, therewith enabling a conversation between them.

10. The instructor unit according to claim 9, wherein the message preparing facility enables the instructor to selectively communicate with a particular participant, with a subgroup of participants, or with all participants.

11. A participant unit comprising:
a participant communication unit to couple said participant unit to an instructor unit by a remote connection to form a training system, further comprising a spatial state sensor module to sense a participant's physical orientation and to provide spatial state data indicative of said physical orientation;
a storage space for storing model data, specifying an environment and spatial state data, said participant communication unit being provided to receive model data specifying an environment from said instructor unit and to transmit spatial state data to said instructor unit, unit; and
a virtual reality rendering unit using said model data and said spatial state data to render a virtual environment in accordance with said model data and said spatial state data.

12. The participant unit according to claim 11, wherein the communication unit is further provided to receive spatial state data of at least one further participant using a further participant unit coupled to said instructor unit in said training system, and wherein the virtual reality rendering unit is arranged to render an avatar of said at least one further participant being arranged in said virtual environment in accordance with said spatial state data.

13. The participant unit according to claim 11, wherein the virtual reality rendering unit includes a 3D rendering module for rendering 3 dimensional image data and a headset to display said 3 dimensional data as 3 dimensional images to be perceived by the respective participant carrying the headset.

14. The participant unit according to claim 11, comprising at least one state sensor for sensing a detectable feature associated with a mental and/or physical state of the participant and for providing state data indicative of said sensed detectable feature, the participant communication unit being arranged to transmit said state data to said instructor unit.

15. The participant unit according to claim 14, wherein said at least one state sensor includes the spatial state sensor module.

16. A training system comprising:
the instructor unit according to claim 1; and
a plurality of participant units, each participant unit comprising:
a participant communication unit to couple said participant unit to an instructor unit by a remote connection to form a training system, further comprising a spatial state sensor module to sense a participant's physical orientation and to provide spatial state data indicative of said physical orientation;
a storage space for storing model data, specifying an environment and spatial state data, said participant communication unit being provided to receive model data specifying an environment from said instructor unit and to transmit spatial state data to said instructor unit, unit; and
a virtual reality rendering unit using said model data and said spatial state data to render a virtual environment in accordance with said model data and said spatial state data,
wherein said instructor unit and the plurality of participant units are communicatively coupled to each other by a remote connection.

17. A method for collaborative training of a plurality of participants at respective participant locations by an instructor at an instructor location, at least one of said participant locations being remotely arranged with respect to the instructor location, the method comprising the step of:
in said instructor location rendering image data in a display space perceivable by the instructor, said display space comprising spatial regions associated with respective participants;
in a storage space maintaining applicant specific data, including at least data associating each participant with a respective spatial region in said display space and virtual environment control data for specifying a virtual environment to be rendered for said participant;
communicating said virtual environment control data to said respective participants;
at said respective participant locations rendering a virtual environment for said participants in accordance with said communicated virtual environment control data;
in said instructor location, receiving control input from the instructor in the form of a spatial relationship between a user gesture and the display space;
detecting a spatial region identified by said gesture and modifying the virtual environment control data of the participant associated with said identified spatial
communicating the virtual environment control data of the participant; and
modifying the virtual environment for said participant in the participants' location in accordance with said communicated virtual environment control data.

18. A computer program product embodied on a non-transitory computer readable medium, comprising a program with instructions for execution by a programmable device, the program causing the programmable device to execute one or more of the steps as defined in claim 17.

19. The instructor unit according to claim 2, the storage facility further storing participant state data for respective participants.

20. The instructor unit according to claim 2, the storage facility further storing authorization data, specifying which participant data is shared with other participants and wherein the message preparing facility prepares messages for distribution of participant data to other participants in accordance with said authorization data.
